(19) United States
(12) Patent Application Publication
(10) Pub. No.: US 2025/0028933 A1
(43) Pub. Date: Jan. 23, 2025

(54) SYSTEM, DEVICES AND/OR PROCESSES FOR EXECUTING A NEURAL NETWORK ARCHITECTURE SEARCH

(71) Applicant: Arm Limited, Cambridge (GB)

(72) Inventors: Gerti Tuzi, Austin, TX (US); Dibakar Gope, Austin, TX (US)

(21) Appl. No.: 18/356,091

(22) Filed: Jul. 20, 2023

(51) Int. Cl. G06N 3/045; G06N 3/08

(52) U.S. Cl. CPC G06N 3/045; G06N 3/08

(57) ABSTRACT

Example methods, apparatuses, and/or articles of manufacture are disclosed that may be implemented, in whole or in part, using one or more computing devices to estimate an execution latency of a candidate neural network in a neural network architecture search (NAS) process.

### BACKGROUND

### 1. Field

The present disclosure relates generally to computer generation of designs for neural network processing devices.

### 2. Information

Neural Networks have become a fundamental building block in machine-learning and/or artificial intelligence systems. A neural network may be constructed according to multiple different design parameters such as, for example, quantization, operator type, network depth, layer width, weight bit width, approaches to pruning, just to provide a few example design parameters that may affect the behavior of a particular neural network processing architecture. Particular design choices for such design parameters may be selected based, at least in part, on particular performance and/or cost objectives.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram of a neural network formed in “layers”, according to an embodiment;

FIG. 2 is a flow diagram of a process to estimate a runtime latency of a kernel implemented in a target processing platform, according to an embodiment;

FIG. 3 is a schematic diagram illustrating an association off operators in a candidate neural network with kernels, according to an embodiment;

FIG. 4 is a table listing parameterized kernels implemented in a target processing platform, according to an embodiment;

FIG. 5 is a flow diagram of a process to determine a latency predictor and/or estimator for a candidate neural network, according to an embodiment;

FIG. 6 is a flow diagram of a process to determine features of a sample candidate neural network, according to an embodiment;

FIG. 7 is a flow diagram of a process to identify kernels for a sample candidate neural network to be implemented on a target processing platform, according to an embodiment;

FIG. 8 is a flow diagram of a process to implement a Gumbel-Softmax path derivative estimator, according to an embodiment.

FIG. 9 is a flow diagram of a process for determining predictors and/or estimators of an execution latency of candidate neural networks, according to an embodiment;

FIG. 10 is a flow diagram of a process to execute a NAS, according to an embodiment; and

FIG. 11 is a schematic block diagram of an example computing system in accordance with an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

According to an embodiment, a neural network may comprise a graph comprising nodes to model neurons in a brain. In this context, a “neural network” as referred to herein means an architecture of a processing device defined and/or expressible by a graph including nodes to represent neurons that process input signals to generate output signals, and edges connecting the nodes to represent input and/or output signal paths between and/or among neurons represented by the graph. In particular implementations, a neural network may comprise a biological neural network, made up of real biological neurons, or an artificial neural network, made up of artificial neurons, for solving artificial intelligence (AI) problems, for example. In an implementation, such an artificial neural network may be implemented by one or more computing devices such as computing devices including a central processing unit (CPU), graphics processing unit (GPU), digital signal processing (DSP) unit and/or neural processing unit (NPU), just to provide a few examples. In a particular implementation, neural network weights associated with edges to represent input and/or output paths may reflect gains to be applied and/or whether an associated connection between connected nodes is to be excitatory (e.g., weight with a positive value) or inhibitory (e.g., weight with negative value). In an example implementation, a neuron may apply a neural network weight to input signals, and sum weighted input signals to generate a linear combination.

According to an embodiment, edges in a neural network connecting nodes may model synapses capable of transmitting signals (e.g., expressing real number values) between neurons. Responsive to receipt of such a signal, a node/neuron may perform some computation to generate an output signal (e.g., to be provided to another node in the neural network connected by an edge). Such an output signal may be based, at least in part, on one or more weights and/or numerical coefficients associated with the node and/or edges providing the output signal. For example, such a weight may increase or decrease a strength of an output signal. In a particular implementation, such weights and/or numerical coefficients may be adjusted and/or updated as a machine learning process progresses. In an implementation, transmission of an output signal from a node in a neural network may be inhibited if a strength of the output signal does not exceed a threshold value.

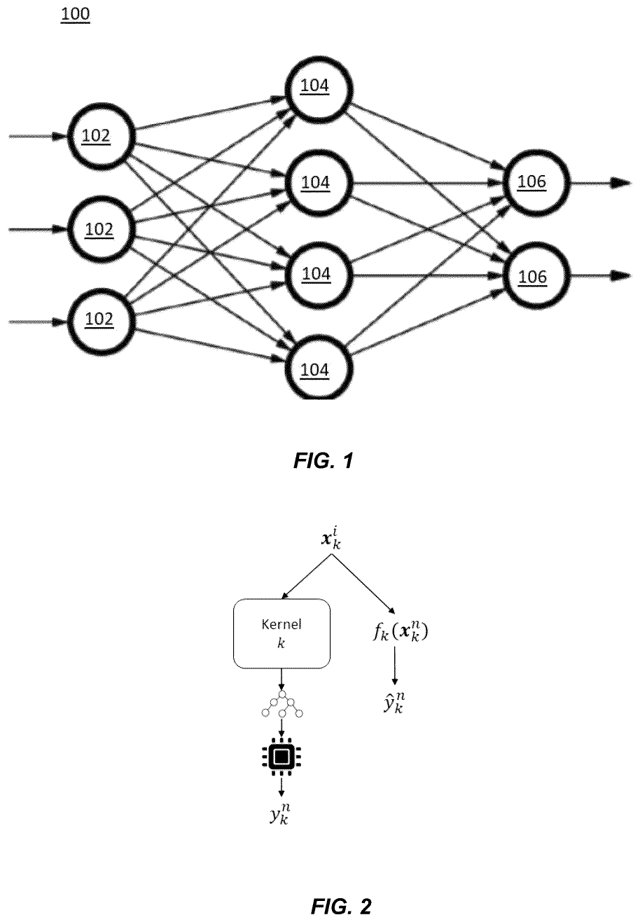

FIG. 1 is a schematic diagram of a neural network 100 formed in “layers” in which an initial layer is formed by nodes 102 and a final layer is formed by nodes 106. Neural network (NN) 100 also includes an intermediate layer formed by nodes 104. Edges shown between nodes 102 and 104 illustrate signal flow from an initial layer to an intermediate layer. Likewise, edges shown between nodes 104 and 106 illustrate signal flow from an intermediate layer to a final layer. While neural network 100 shows a single intermediate layer formed by nodes 104, it should be understood that other implementations of a neural network may include multiple intermediate layers formed between an initial layer and a final layer.

According to an embodiment, a node 102, 104 and/or 106 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node and/or edge of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect. Additionally, an “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In a particular implementation, an activation output value may be computed and/or generated according to an activation function based on and/or responsive to one or more activation input values received at a node.

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

According to an embodiment, a neural network may be structured in layers such that a node in a particular neural network layer may receive output signals from one or more nodes in an upstream layer in the neural network, and provide an output signal to one or more nodes in a downstream layer in the neural network. In one implementation, nodes in a layer of a neural network may uniformly apply the same activation function.

One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples. Another class of layered neural network may comprise a recurrent neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ back propagation techniques to iteratively update neural network weights to be associated with nodes and/or edges of a neural network based, at least in part on “training sets.” Such training sets may include training measurements and/or observations to be supplied as input values that are paired with “ground truth” observations. Based on a comparison of such ground truth observations and associated prediction values generated based on such input values in a training process, weights may be updated according to a loss function using backpropagation.

As pointed out above, a design of a neural network may be optimized for a particular performance and/or cost objective based, at least, in part on selection of options for decisions of particular design parameters such as, for example, network depth, layer width, operation selection, weight quantization and approaches to pruning. In one embodiment, such selected options for design parameters may be defined solely by a human design for a particular purpose. Alternatively, such choices for design parameters may be determined in an automated fashion.

According to an embodiment, design of an efficient and effective neural network architecture may entail substantial human effort and time to develop. Through experimentation, human experts have devised several useful neural network structures such as, for example, attention and residual connection. Given the virtually infinite possible design choices of a neural network architecture, however, manual search for optimal computing architectures may become infeasible. In another embodiment, an automated neural architecture search (NAS) may enable a more rapid approach to arrive at a neural network architecture that approaches optimality.

In particular implementations, a NAS approach may apply an evolutionary algorithm (EA) and/or reinforcement learning (RL) to design neural network architectures automatically. In both RL-based and EA-based approaches, searching procedures may entail validation of accuracy of numerous architecture candidates, which may be computationally expensive. For example, an RL-based method may utilize validation accuracy as a reward to optimize an architecture generator. An EA-based method may leverage validation accuracy to decide whether a model is to be removed from a population of models. In particular implementations, these approaches may employ use of a large amount of computational resources, which may be inefficient and cost prohibitive.

According to an embodiment, design parameters affecting performance of a neural network may include, for example, layer width/number of channels, weight quantization (e.g., bit width), activation quantization (e.g., bit width), operator type, network connectivity, network depth, weight sparsity level and/or activation resolution. It should be understood, however, that these are merely examples of design parameters that may affect performance of a neural network, and that claimed subject matter is not limited in this respect.

According to an embodiment, particular NAS approaches for determining parameters of a computing device to implement a neural network (NN) based inference engine may select from among multiple available design options for a processing architecture. Such an available design option may be defined by and/or limited to available computing options for implementing such a processing architecture. While some techniques may define such available design options by application of a set heuristics and/or rules using a manual approach, such techniques may be limited in providing particular options capable of achieving available optimality given a target hardware and/or other constraints.

A NAS process may select a particular neural network architecture from among multiple network architectures in a “search space” configurable from a set of computing resources. According to an embodiment, a search space may be defined for a particular predefined neural network structure such as a CNN, Transformer neural network, a neural network of a particular number of layers, just to provide a few examples of particular predefined neural network structures for which a search space may define multiple network architectures. For such a particular predefined neural network structure, a search space may characterize and/or define multiple different instances of the particular predefined neural network structure. Such different instances of the particular predefined neural network structure may be differentiated in a search space by associated permutations of available design choices for features such as, for example, activation quantization, weight quantization, channel width for particular layers, operator selection for activation functions or search depth, just to provide a few examples of possible design choices that may be decisions for features of a particular predefined neural network structure. In one particular example implementation, a “search space” may be represented as a graph (e.g., stored as signals and/or states in a storage device) that is searchable in an automated NAS process.

In particular implementations, a process to select from among available candidate options for a decision regarding a feature of a neural network processing architecture may be guided, at least in part, by a computed loss function, such as a loss function L(W,Θ) according to expression (1) as follows:

$$L ( W , Θ ) = f [ {L}_{fun} ( W , Θ ) , {L}_{lat} ( W , Θ ) ] \qquad ( 1 )$$

where:
   W is a set of selectable weights to be associated with nodes in the neural network processing architecture;
   Θ is a state parameter based on and/or expressing a design space of candidate neural networks;
   L_{fun} (W, Θ) is a loss function based on functionality of the neural network processing architecture (e.g., prediction accuracy); and
   Lₗₐₜ (W, Θ) is a loss function based on execution latency.

According to an embodiment, a NAS process may traverse a search space over multiple iterations to select and/or determine a neural network architecture. Such traversal of a search space may be guided, at least in part, by application of a gradient computed based on a loss function, such as a loss function computed according to expression (1).

To support a latency-guided NAS process, it may be desirable to quantify a runtime/execution latency of candidate neural networks being evaluated on a target runtime platform or hardware to, for example, evaluate a loss function such as a loss function according to expression (1). As a number of candidate neural network architectures becomes very large, however, direct latency measurements of candidate neural network architectures over NAS runs becomes infeasible. According to an embodiment, latency estimators may be used in lieu of obtaining empirically determined/directly measured execution latencies for all candidate neural network architectures to be evaluated in a NAS process.

According to an embodiment, techniques for implementing latency estimators may include, for example, per-component latency estimators and end-to-end latency estimators. In one particular implementation, an end-to-end latency estimator technique may use graph convolutional networks (GCNs) for estimating latency. In another particular implementation, a multi-layer perception (MLP) and an embedding of a candidate neural network (NN) may be used to predict/estimate an associated execution latency. These particular techniques may have advantages in their simplicity of learning black-box optimizations from training data sets. However, these techniques may be sample intensive to capture complexities of multiple layer execution for different platforms and search spaces, and in lacking an ability to generalize to unseen architectures. Additionally, effective implementation of GCN and MLP in an end-to-end latency estimator techniques may entail a re-training of estimators from scratch for each search space, as an embedding of candidate NNs may be tied to particular definitions.

According to an embodiment, a component of a candidate NN architecture may be derived as an optimized combination of operations for a given hardware platform to form a “kernel” that executes a particular function. One such particular function may be implemented by a fusion of operators (e.g., fusion of Conv2D+Batch Normalization+Activation). Such a component may also be executed independently if global optimizations are not performed. Examples of global optimizations for forming a kernel may be achieved through, for example, parallel processing or overlapping execution of components. Component execution latencies may vary based, at least in part, on different topological parameters (e.g., channel I/O, kernel size, etc.). In one aspect, a component may be viewed as one or more operations, where topological parameters are inputs and an independent execution time is provided as an output. According to an embodiment, a runtime latency of such a component may be approximated according to a function. In one implementation, aspects of a parametrized function to approximate a runtime latency of a component may be learned via component learners. Here, a component learner's inputs may be features of the component and the component learner's output may be an estimated latency. Moreover, for a given platform, there are a finite number of possible components. Some of these components can share types of operators. For example, the combinations “Conv2D+BN+ReLU” and “Conv2D+BN”, while they share the {Conv2D, BN} operators, are different components since they may encapsulate different local optimizations.

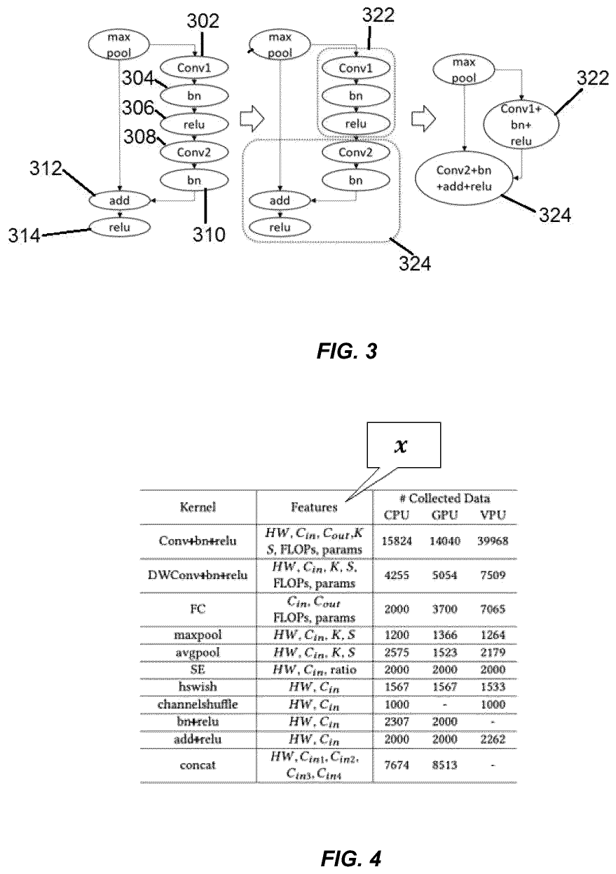

According to an embodiment as shown in FIG. 3, a series of operators to be executed in a candidate NN may comprise Conv1, bn, relu, Conv2, bn, add and relu. According to an embodiment, operators “Conv1,” “bn,” “relu,” “Conv2” and “add” may define activation functions for nodes in associated layers of a candidate NN. In an implementation, nodes forming a particular layer of a candidate NN may uniformly implement the same activation function for all nodes in the particular layer. For example, activation functions of nodes in a first layer 302 may be uniformly implemented as operator “Conv1,” activation functions of nodes in a second layer 304 may be uniformly implemented as operator “bn,” activation functions of nodes in a third layer 306 may be uniformly implemented as operator “relu,” activation functions of nodes in a fourth layer 308 may be uniformly implemented as operator “Conv2,” activation functions of nodes in a fifth layer 310 may be uniformly implemented as operator “bn,” activation functions of nodes in a sixth layer may 312 be uniformly implemented as operator add and activation functions of nodes in a seventh layer 314 may be uniformly implemented as operator “relu.”

A first collection of operators comprising Conv1, bn and relu on layers 302, 304 and 306 may be optimized for hardware execution as kernel 302. Similarly, a second collection of operators 304 comprising Conv2, bn, add and relu on layers 308, 310, 312 and 314 may be optimized for hardware execution as kernel 324. The table of FIG. 4 indicates kernels defined for a particular hardware platform along with features of particular defined kernels. As pointed out above, per-component latencies may be computed for individual kernels. FIG. 2 illustrates a process for training an estimator for a kernel x^{k}. Estimator fₖ(xₖⁿ) may compute an estimated execution latency of a kernel x^{k} based on a sample of available features xₖⁿ (e.g., as shown in the center column of the table of FIG. 4) of kernel x^{k} Parameters of an estimator fₖ (xₖⁿ) may be trained to compute an estimate ŷₖⁿ where n is an instance of a sample of kernel based on directly measured/empirically determined actual latency yₖⁿ. For example, fₖ(xₖⁿ) may be formed as a neural network with parameters that may be trained using backpropagation based on a gradient of a loss function computed from estimate ŷₖⁿ and measured/empirically determined actual latency yₖⁿ.

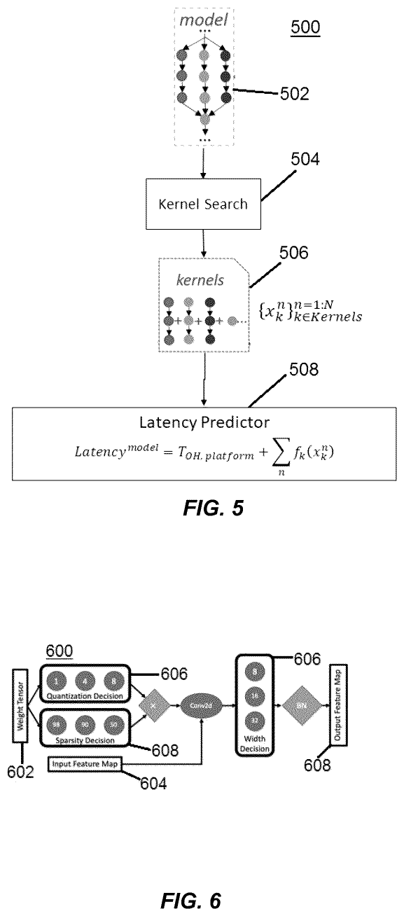

According to an embodiment, one component of actual latency Latencyₘ of a sample neural network m may include component latencies imparted from execution of individual kernels in a series of kernels. Such component latencies imparted from execution of individual kernels in a series of kernels {xₖⁿ}_{k∈Kernels}^{n=1:N} may be modeled by estimators {fₖ(xₖⁿ)}_{k∈Kernels}^{n=1:N}. FIG. 5 is a flow diagram of a process 500 for determining a model latency estimator using a per-component approach. A model 502 may be defined in a search space in the course of a NAS process. Model 502 may define parameters to specify features of a particular candidate neural network such as, for example, a neural network topology, channel widths, quantization, activation functions, just to provide a few examples of parameters that may define a candidate neural network. Additionally, parameters defined in model 502 may specify and/or define features of a particular candidate neural network tied to a particular target hardware platform.

According to an embodiment, kernel search operation 504 may associate operators in model 502 that may be optimally combined in kernels, such as kernels identified in the table of FIG. 4, for example. In one particular implementation, kernel search 504 may be performed, at least in part, by a compiler for a particular target computing platform. In another particular implementation, such kernels may be included in a library of kernels defined in a compiler that is to be used in implementing the candidate neural network of model 502 on a target platform. Such a target platform may be defined, at least in part, by a hardware platform and an suitable compiler to implement candidate neural networks. Kernel search operation 504 may map operators in model 502 to kernels {xₖⁿ}_{k∈Kernels}^{n=1:N} to define an implementable processing structure 506 that is equivalent to model 502. Implementable processing structure 506 may define kernels selected by a compiler from a library of kernels and parameters to specify implementation of the selected kernels (e.g., from center column of FIG. 4).

An execution latency Latencyₘ of a sample candidate neural network m in a NAS process may be estimated, at a first approximation, by a sum of estimated execution latencies of constituent kernels making up the sample neural network m. According to an embodiment, such a sum of estimated execution latencies of constituent kernels may be a biased estimator. For example, such a sum of estimated latencies of constituent kernels, by itself, may deviate from an expected execution latency of a sample neural network m by a positive or negative offset. For example, if a sum of estimated execution latencies of constituent kernels does not account for additional efficiencies of inter-kernel integration performed by a compiler, such a sum of estimated execution latencies of constituent kernels may overestimate an end-to-end execution latency of sample neural network m. Conversely, if a sum of estimated execution latencies of constituent kernels does not account for particular inefficiencies inherent in inter-kernel integration performed by a compiler, such a sum of estimated execution latencies of constituent kernels may underestimate an end-to-end execution latency of sample neural network m.

According to an embodiment, a sum of estimated execution latencies of constituent kernels of a sample neural network m may be augmented by an “overhead latency” to provide an estimator of an end-to-end execution latency. Such an overhead latency may account for a bias in an estimate of an end-to-end latency of sample neural network m computed based on a sum of estimated latencies of constituent kernels. In one implementation, using per component latency estimators fₖ(xₖⁿ) for kernels {xₖⁿ}_{k∈Kernels}^{n=1:N}, an estimated and/or predicted latency Latency^{model} for model 502 may be computed according to expression (2) as follows:

$${Latency}^{model} = {T}_{O H , platform} + {\sum }_{n} {f}_{k} ( {x}_{k}^{n} ) , \qquad ( 2 )$$

where T_{OH,platform} is an estimated overhead latency for the target platform.

In a particular implementation, estimated overhead latency T_{OH,platform} may be computed based on a statistical sampling of overhead latencies directly measured from execution of multiple different neural networks implemented on the target platform. For example, T_{OH,platform} may be computed as an expected (e.g., average) value from multiple kernelized-estimates deployed on a particular target platform. This may comprise, for example, an average offset from multiple representative neural networks minus estimates of latencies of individual kernels for each of the representative neural networks.

As pointed out above in expression (2), a per-component technique for estimating a latency for execution of operators (e.g., convolution), and an overall latency of a candidate NN may be estimated by summing estimated latencies of the individual kernels to implement the operators. In some implementations, per-component technique for estimating latency may advantageously enable reuse of component latency estimates to generalize unseen architectures while accounting for hardware estimations. Nonetheless, estimators implemented in these per-component latency estimation techniques typically are not differentiable and do not account for latency due to processing overhead with sufficient precision.

Briefly, particular embodiments are directed to a technique to compute an estimate of an execution latency of a candidate neural network architecture based, at least in part, on: a combination of estimated latencies of individual kernels to be executed by the candidate neural network; and an estimate of an overhead latency computed based, at least in part, on design choices of the candidate neural network. In one particular implementation, such an estimate of an overhead latency may be computed based, at least in part, on a sample neural network in a search space and/or a topology of the candidate neural network.

By computing an estimated overhead latency based, at least in part, on features particular to a sample neural network in a search space and/or topology, a more robust latency estimator may be applied across unseen architectures in the search space. As discussed below, particular implementations of a robust estimator of overhead latency applicable across such unseen architectures may also be differentiable to enable implementation in a loss function applied in a NAS process. Such a more robust estimator of overhead latency may enable training a latency estimator for a neural network using smaller training sets/fewer samples. Such a more robust estimator may also enable application of the estimator to a greater variety of arbitrary neural network search spaces without significant loss in accuracy.

In another embodiment, a robust overhead latency estimator may comprise: a first neural network to compute an estimated latency based, at least in part, on an input tensor; and a second neural network having parameters trained to map sample neural networks of multiple neural network search spaces to the input tensor. In one particular implementation, parameters of the first and second neural networks may be trained separately. In another particular implementation, the second neural network may comprise an RNN, and may be configurable to map features of neural networks from any one of a variety of different search spaces to provide the input tensor of the first neural network. For example, the second neural network may be capable of mapping features of neural networks of different depths/lengths to an input tensor of the first neural network, thereby enabling an overhead latency estimator to be search space agnostic.

FIG. 6 is a flow diagram illustrating elements of a search space from which candidate neural network architectures may be selected in a NAS process. Such a candidate neural network architecture may be implemented, at least in part, by activation weights in a weight tensor 602, and process an input feature map formed in an input tensor 604 to provide an output feature map in an output tensor 608. Additional parameters of a candidate neural network in a search space may include quantification at block 606, channel sparsity at block 608 and channel width at block 606. It should be understood, however, that these are merely examples of design parameters that may define a sample candidate neural network in a NAS search space, and claimed subject matter is not limited in this respect.

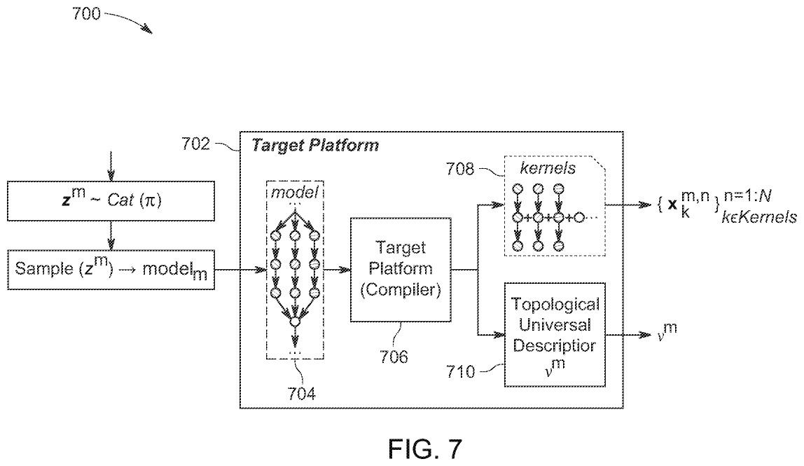

FIG. 7 is a flow diagram of a process 700 to formulate parameters of a per-component latency estimator for a candidate NN architecture. According to an embodiment, features of a candidate neural network architecture z^{m} may be sampled in an iteration of a NAS process from a categorical distribution z^{m}˜Cat(π) according to probabilities It defined for a particular search space. In one particular implementation, a sample candidate NN architecture z^{m}˜Cat(π) may be determined at least in part according to process 600 shown in FIG. 6. It should be understood, however, that this is merely one example of how a sample candidate NN architecture may be determined, and claimed subject matter is not limited in this respect. According to an embodiment, sample candidate NN architecture z^{m}˜Cat(π) may be mapped to a particular target platform 702 which is defined, at least in part, by a particular target hardware and a compiler to be installed on the particular target hardware. Here, sample candidate NN architecture z^{m}˜Cat(π) may be mapped to a model 704 defining, for example, a number of NN layers, number of channels at each layer, activations, quantization and/or operators to implement activation functions at layers.

Block 706 may construct an implementation of model 704 in target platform 702. For example, block 706 may determine a set of kernels 708 from combinations of operators that are to implement activation functions to be executed at nodes in NN layers defined in model 704. Such combinations of operators may be defined by a compiler and/or instruction set architecture of a target processor architecture, for example. For example, such operators may comprise Conv1, bn, relu, Conv2, bn, add and relu, just to provide a few examples. Block 706 may further associate combinations of operators defined at block 706 with a set of kernels {xₖⁿ}_{k∈Kernels}^{n=1:N}. As illustrated above, block 706 may construct an implementation 708 to include a set of kernels {xₖⁿ}_{k∈Kernels}^{n=1:N} according to a mapping (e.g., as shown in the table in FIG. 4). Such a set of kernels {xₖⁿ}_{k∈Kernels}^{n=1:N} may define distinct kernels that optimally correspond to operators as shown in FIG. 3, for example. Also, block 710 may define a topological descriptor v^{m} which may comprise a vector parameter to characterize a topology of candidate neural network m.

According to an embodiment, an execution latency of a sample candidate neural network architecture may be estimated according to expression (3) as follows:

$${( {z}^{m} )}_{{z}^{m} ∼ Ca t ( π )} = {g ( {z}^{m} , {v}^{m} , w )}_{\vert {z}^{m} ∼ Ca t ( π )} + {\sum }_{n} {f}_{k} ( {x}_{k}^{m , n} ) , \qquad ( 3 )$$

where:
g is an overhead latency estimation function with trainable parameters w;
z^{m} is an mth candidate neural network obtained from a search space sampled according to categorical probability mass function Cat(π); and
v^{m} is a topological descriptor for the mth candidate neural network.

In another implementation, a latency estimator may be formulated to be based on a sample z^{m} but independently of topological descriptor v^{m} according to expression (4) as follows:

$${( {z}^{m} )}_{{z}^{m} \sim Cat ( π )} = {g ( {z}^{m} , w )}_{\vert {z}^{m} - Cat ( π )} + {\sum }_{n} {f}_{k} ( {x}_{k}^{m , n} ) . \qquad ( 4 )$$

According to an embodiment, overhead latency estimation function g(z^{m}, v^{m}, w)_{|z}_{^{m}}_{˜Cat(π)} and/or g (z^{m}, w)_{|z}_{^{m}}_{˜Cat(π)} may be formulated as a neural network (e.g., an MLP) where trainable parameters w comprise weights to be applied by activation functions of nodes of the neural network.

In the particular implementations of a latency estimator formulated according to expressions (3) and (4), a learned overhead function g(z^{m}, v^{m}, w)_{|z}_{^{m}}_{˜Cat(π)} or g(z^{m}, w)_{|z}_{^{m}}_{˜Cat(π)} may depend on a particular definition of a search space where a sample instance z^{m} may follow a categorical distribution over such a search space (e.g., Cat(π)). These particular implementations of a globally learned overhead function g may be tied to a particular defined search space. This may entail, for example, a retraining of such a global overhead function for other, additional search spaces (while local component learners may still be re-used for unseen search spaces). According to an embodiment, a functional definition may enable an extension of a search space-specific approach to provide a search space agnostic formulation of overhead function g. According to an embodiment, a sample z^{m} may be represented as a sequence of operators. Here, using a finite dictionary of possible operations on a target platform, an operations sentence of arbitrary length may be constructed, which may then be processed by a recurrent function-such as a recurrent neural networks (RNN). Using a fixed length output of an RNN, an overhead function may be applicable to multiple types of architectures (e.g., search space independent) according to expression (5) as follows:

$${( {z}^{m} )}_{{z}^{m} \sim Cat ( π )} = {g ( RNN ( ℋ ( {z}^{m} ) , {w}_{RNN} ) , {ν}^{m} , w )}_{\vert {z}^{m} \sim Cat ( π )} + {\sum }_{n} {f}_{k} ( {x}_{k}^{m , n} ) , \qquad ( 5 )$$

where:
   w_{RNN} are trainable weights to be applied at nodes of an RNN to compute search space-agnostic parameters; and
   [symbol] performs a mapping from the selected operators for a sample candidate NN z^{m} during an iteration of a NAS process to an input tensor of the RNN.

According to an embodiment, weights w_{RNN} may be trained over a variety of search spaces such that application of RNN( [symbol] (z^{m}) may be generalized for multiple search spaces. For example, weights w_{RNN} may be trained over a variety of search spaces for sampling a candidate neural network architecture z^{m} over multiple categorical distributions for It of the variety of search spaces.

A latency estimator according to expression (3), expression (4) or expression (5) may also be formulated to provide a differentiable loss function. In particular implementations, a NAS process may attempt to optimize a neural network search to a target latency Latency_{target}. One such loss function L_{Latency} may be computed according to expression (6) as follows:

$${L}_{L a t e n c y} = {E}_{z ∼ Ca t ( π )} [ 0.5 {( {Latency}_{target} - ( z ) )}^{2} ] . \qquad ( 6 )$$

As pointed out above, a NAS process may be carried out by iterations of samples over a search space directed by a gradient descent applied to a loss function. Such a loss function may include L_{Latency} combined with loss components directed to predication performance/accuracy, for example. In an embodiment, a gradient of loss function component L_{Latency} in expression (6) may be computed according to expression (7) as follows:

$$\frac{d}{d π} {E}_{z \sim Cat ( π )} [ 0.5 {( {Latency}_{target} - ( z ) )}^{2} ] = {E}_{z \sim Cat ( π )} [ 0.5 \frac{d}{d π} {( {Latency}_{target} - ( z ) )}^{2} ] \qquad ( 7 )$$

Substituting a latency estimator in expression (3) for [symbol] (z), a gradient according to expression (7) may then be computed according to expression (8) as follows:

$$0.5 \frac{d}{d π} {( {Latency}_{target} - ( z ) )}^{2} = [ {Latency}_{target} - {g ( {z}^{m} , {ν}^{m} , w )}_{\vert {z}^{m} ∼ Ca t ( π )} - {\sum }_{n} {f}_{k} ( {x}_{k}^{m , n} ) ] \frac{d}{d π} {g ( {z}^{m} , {ν}^{m} , w )}_{\vert {z}^{m} ∼ Ca t ( π )} \qquad ( 8 )$$

According to an embodiment,

$$\frac{d}{d π} {g ( {z}^{m} , {ν}^{m} , w )}_{\vert {z}^{m} ∼ Ca t ( π )}$$

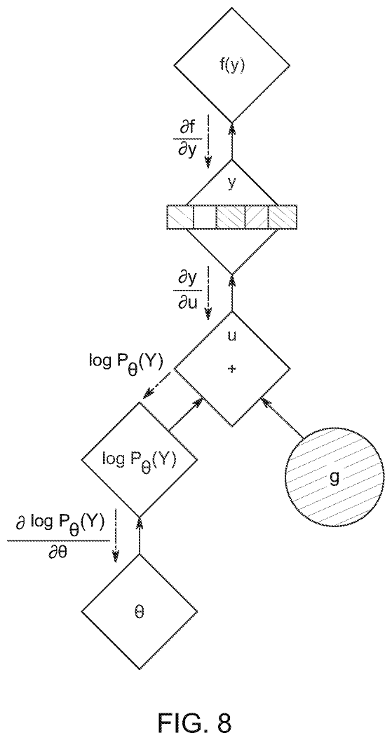

may be reparameterized by application of a Gumbel-Softmax path derivative estimator (e.g., as shown in FIG. 8). For [symbol] (z) based on expression (4),

$$\frac{d}{d π} {g ( {z}^{m} , w )}_{\vert {z}^{m} ∼ Ca t ( π )}$$

may be similarly reparameterized by application of a Gumbel-Softmax path derivative estimator according to operations shown in FIG. 8, for example.

In another embodiment, an overhead component of a latency estimator for a candidate neural network may be modeled as coefficients pₖ^{m} to be applied multiplicatively to corresponding per-component latency estimators fₖ(xₖ^{m,n}). For an arbitrary NAS search space, for example, an associated kernel space Kernels*⊂Kernels where kernel k*∈Kernels*, may have a potentially smaller set (e.g., subset) of kernels than all possible kernels for a given target platform. Here, an overhead latency estimation function for such a search space may be expressed as g*: [symbol] ^{|z|×|v|}→ [symbol] ^{|Kernels*|}, and p^{m}=g*(z^{m}, v^{m}, w)_{|z}_{^{m}}_{˜Cat(π)}. An overhead component of an estimated execution latency of a candidate neural network m may then be incorporated in an execution latency estimate computed according to expression (9) as follows:

$${( {z}^{m} )}_{{z}^{m} ∼ Ca t ( π )} = {\sum }_{{k}^{*}} {p}_{{k}^{*}}^{m} {f}_{{k}^{*}} ( {x}_{{k}^{*}}^{m} ) . \qquad ( 9 )$$

The per-component latency estimator of expression (9) may also be differentiable to enable a computation of a gradient of a loss function incorporating such a per-component latency estimator. For example, a loss function of expression (6) incorporating expression (9) may be formulated according to expression (10) as follows:

$${L}_{L a t e n c y} = {E}_{z ∼ Ca t ( π )} [ 0.5 {( {Latency}_{target} - {\sum }_{n} {p}_{{k}^{*}}^{m} {f}_{{k}^{*}} ( {x}_{{k}^{*}}^{m , n} ) )}^{2} ] . \qquad ( 10 )$$

A gradient of the loss function of expression (10) may then be computed according to expression (11) as follows:

$$\frac{d}{d π} {( {Latency}_{target} - ( z ) )}^{2} = [ {Latency}_{target} - {\sum }_{n} {p}_{{k}^{*}} {f}_{{k}^{*}} ( {x}_{{k}^{*}}^{n} ) ] \frac{d}{d π} ( {\sum }_{n} {p}_{{k}^{*}} {f}_{{k}^{*}} ( {x}_{{k}^{*}}^{n} ) ) \qquad ( 11 )$$

The last term of expression (11) may be simplified according to expression (12) as follows:

$$\frac{d}{d π} ( {\sum }_{n} {p}_{{k}^{*}} {f}_{{k}^{*}} ( {x}_{{k}^{*}}^{n} ) ) = {\sum }_{n} \frac{d}{d π} ( {p}_{{k}^{*}} ) {f}_{{k}^{*}} ( {x}_{{k}^{*}}^{n} ) \qquad ( 12 )$$

As pointed out above, latency estimators according to expressions (3), (4), (5) and (9) each include one or more an overhead latency terms that are differentiable over π that is categorically distributed in a particular search space. Thus, in implementations of a latency estimator according to expressions (3), (4), (5) or (9) in a loss function for a NAS process, a gradient descent applied to the loss function may account for an overhead latency bias to a sum of estimators of execution latency of constituent kernels, or weights applied to estimator of execution latency of constituent kernels, of a sample neural network.

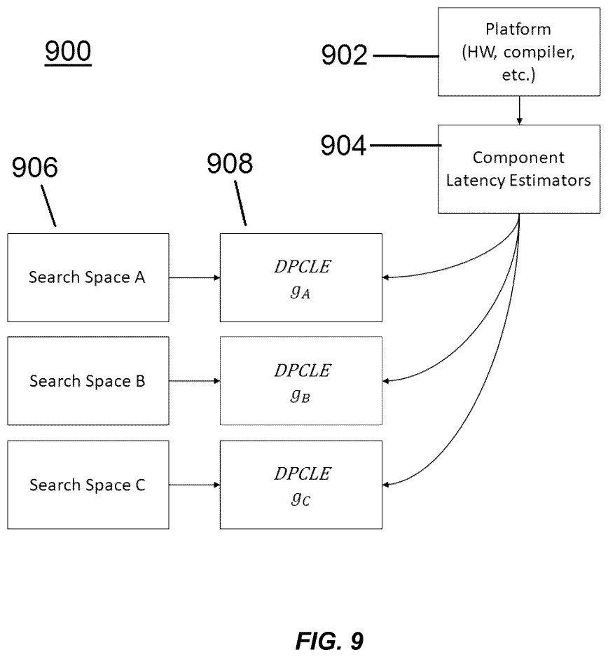

FIG. 9 is a flow diagram of a process 900 for determining parameters of a latency estimator for a candidate neural network in a NAS process. Such a latency estimator may comprise an overhead latency component that is dependent on features of a sampled candidate NN (e.g., g(z^{m}, w)_{|z}_{^{m}}_{˜Cat(π)}, g(z^{m}, v^{m}, w)_{|z}_{^{m}}_{˜Cat(π)} or g*(z^{m}, v^{m}, w)_{|z}_{^{m}}_{˜Cat(π)}), and be formulated according to expression (3), (4) or (9), for example. According to an embodiment, parameters of per-component latency estimators (e.g., fₖ(xₖⁿ)) may be determined at block 904 for a particular target platform 902 defined, at least in part, by a target hardware platform and compiler. Block 904 may, for example, determine parameters for estimators of latency of kernels, such as kernels in a library of kernels listed in the table of FIG. 4. In block 904, for example, a compiler may map operations defined in a sample neural network to kernels. As pointed out above, a per-component latency estimator may be formulated as a neural network with parameters that may be trained using backpropagation based on a gradient of a loss function, wherein the loss function is computed on a training iteration/epoch n from estimate ŷₖⁿ and measured actual latency yₖⁿ. Here, multiple training sets 1, 2, . . . , N may be defined to include values to be processed by a defined parameterized kernel x^{k} (e.g., parameterized to be sampled according to features in table of FIG. 4) over multiple training epochs. Values of a training set n∈1, 2, . . . , N in a corresponding training epoch n may be processed by an actual execution of kernel k on the target platform to determine a measured actual latency yₖⁿ. Also for the corresponding training epoch n, an input tensor for a neural network implementation of fₖ(xₖⁿ) may receive values of the training set n to compute estimate ŷₖⁿ. In an implementation, such a neural network implementation of fₖ (xₖⁿ) may be defined by a particular neural network structure and weights θₖ to be applied in corresponding activation functions computed at nodes in the particular neural network structure. A loss function may be computed according to expression (13) as follows:

$${L}^{n} ( {θ}_{k}^{n} ) = 0.5 {( {y}_{k}^{n} - {\hat{y}}_{k}^{n} )}^{2} = 0.5 {( {y}_{k}^{n} - {f}_{k} ( {x}_{k}^{n} , {θ}_{k}^{n} ) )}^{2} . \qquad ( 13 )$$

It should be understood that this is merely example of a loss function that may be applied for determining parameters of an estimator of execution latency of a kernel x^{k}, that other types of loss functions such as an absolute error, average percentage error or squared logarithmic error function may be used, and that claimed subject matter is not limited in this respect. Applying a gradient descent to Lⁿ(θⁿₖ) in a backpropagation operation, weights θₖⁿ may be updated to θₖⁿ⁺¹ for application in a subsequent training epoch n+1 where a subsequent loss term Lⁿ⁺¹ (θⁿ⁺¹ₖ) may be computed according to expression (13). Application of a gradient descent to Lⁿ⁺ⁱ(wₖ) may continue in subsequent training epochs with θⁿ⁺ⁱₖ until Lⁿ(θₖⁿ⁺¹) is sufficiently small.

Following training of parameters of fₖ for kernels in a library of kernels, blocks 908 may determine parameters for one or more overhead latency estimators g_{SS} for a NAS search space SS∈A, B, C. A block 908 may, for example, determine trainable parameters for an estimator of an overhead latency component (e.g., trainable parameters w for g(z^{m}, w)_{|z}_{^{m}}_{˜Cat(π)}, g(z^{m}, v^{m}, w)_{|z}_{^{m}}_{˜Cat(π)} or g*(z^{m}, v^{m}, w)_{|z}_{^{m}}_{˜Cat(π)}), for a corresponding search space A, B or C. As pointed out above, an overhead latency estimator may be formulated as a neural network (e.g., MLP) with parameters that may be trained using backpropagation based on a gradient of a loss function computed from an estimated latency and measured/empirically determined actual latency. Here, multiple training sets 1, . . . , M may be defined to include parameters of neural networks (e.g., z^{m} and/or v^{m}) sampled from a search space. Parameters of a training set m∈1, 2, . . . , M in a corresponding training epoch m may be processed by an actual execution of a neural network defined by z^{m} and/or v^{m} in a search space SS on the target platform to determine a measured/empirically determined actual latency Latency_{SS}^{m}. Also for the corresponding training epoch m, an input tensor for an implementation of g may receive values defining z^{m} and/or v^{m} of the training set m to compute estimate [symbol] _{g}_{_{SS}}^{m} In an implementation, such a neural network implementation of g may be defined by a particular neural network structure (e.g., MLP) and weights w_{g}_{_{SS}}^{m}, to be applied in corresponding activation functions computed at nodes in the particular neural network structure. A loss function may be computed according to expression (14) as follows:

$${L}_{{g}_{ss}}^{m} = {[ {Latency}_{S S}^{m} - {{g}_{s s}}_{m}^{} \vert {w}_{{g}_{s s}}^{m} ]}^{2} . \qquad ( 14 )$$

Applying a gradient descent to L_{g}_{_{SS}}^{m}, in a backpropagation operation, weights w_{g}_{_{SS}}^{m} may be updated to w_{g}_{_{SS}}^{m+1} for application in a subsequent training epoch m+1 where a subsequent loss term L_{g}_{_{SS}}^{m+1} may be computed according to expression (13).

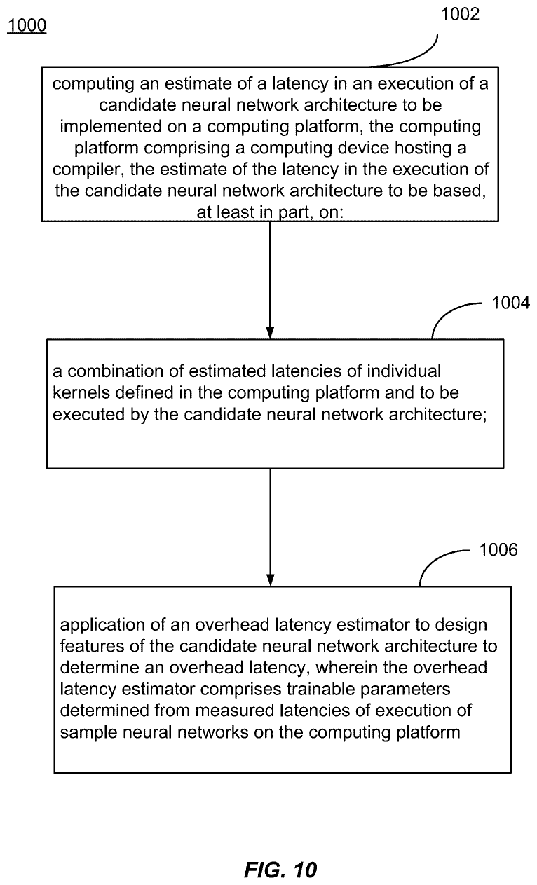

FIG. 10 is a flow diagram of a process 1000 for estimating a latency in an execution of a candidate neural network, such as a candidate neural network defined in a NAS process, for example. As set forth in block 1002, a computer implemented process may compute an estimate of a latency in an execution of a candidate neural network architecture to be implemented on a computing platform comprising a computing device. Such an estimate of an execution latency may be determined for a candidate neural network sampled from a search space in a NAS process. As illustrated at block 706 in FIG. 7, such a computing platform may comprise a compiler capable of mapping operators in the candidate neural network to kernels 708 to be implemented on the computing platform.

As set forth in block 1004, an estimated latency determined in block 1002 may be computed by a combination of estimated latencies of individual kernels. In an implementation, such a combination of latencies may be computed at least in part by estimators derived for the individual kernels such as fₖ(xₖⁿ). Such a combination may comprise a sum of estimates computed by estimators fₖ(xₖⁿ).

As set forth in block 1006, an estimated latency determined at block 1002 may be further computed based, at least in part, on application of an overhead latency estimator to design features of the candidate neural network. As pointed out above, in different embodiments such an overhead latency estimator may be formulated as (z^{m}, v^{m}, w)_{|z}_{^{m}}_{˜Cat(π)}, g(z^{m}, w)_{|z}_{^{m}}_{˜Cat(π)} g(RNN( [symbol] (z^{m}), w_{RNN}), v^{m}, w)_{|z}_{^{m}}_{˜Cat(π)}, or g*(z^{m}, v^{m}, w)_{|z}_{^{m}}_{˜Cat(π)}.

In one implementation, application of an overhead latency at block 1006 may comprise multiplying the estimated latencies computed at block 1002 by scalers determined based on trainable parameters, such as pₖ_{⁺}^{m}, as shown in the example of expression (9). In another implementation, a combination of estimated latencies of kernels at block 1004 may comprise a sum of individual estimated latencies associated with the individual kernels and application of an overhead latency at block 1006 may comprise adding a latency overhead term g(z^{m}, v^{m}, w)_{|z}_{^{m}}_{˜Cat(π)}; g(z^{m}, w)_{|z}_{^{m}}_{˜Cat(π)} or g(RNN( [symbol] (z^{m}), w_{RNN}), v^{m}, w)_{|z}_{^{m}}_{˜Cat(π)} to the sum as shown in expressions (3), (4) and (5). In the particular example, of expression (5) overhead latency estimator g (RNN( [symbol] (z^{m}), w_{RNN}), v^{m}, w)_{|z}_{^{m}}_{˜Cat(π)} comprises a first neural network to compute an estimated latency based, at least in part, on an input tensor; and a second neural network having parameters trained to map sample neural networks of multiple neural network search spaces to the input tensor.

In this context, an “empirically determined latency” of a neural network as referred to herein means an observation/measurement of latency an actual execution of the neural network on inference hardware (e.g., one or more NPUs) to perform a particular computational task. In one example, an empirically determined latency of a candidate neural network may be obtained by application of a hardware implementation of the candidate neural network to one or more input tensors to compute one or more output tensors. In another example, an empirically determined latency of a candidate neural network may be obtained by application of a simulated/emulated implementation of the candidate neural network to one or more input tensors to compute one or more output tensors. Here, such an empirically determined latency may be obtained as an observed/measured latency to compute the output tensor. It should be understood, however, these are merely examples of how a latency of a neural network may be empirically determined, and claimed subject matter is not limited in this respect.

In the context of the present patent application, the term “connection,” the term “component” and/or similar terms are intended to be physical but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modelled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted that an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public. According to an embodiment, a signal packet and/or frame may comprise all or a portion of a “message” transmitted between devices. In an implementation, a message may comprise signals and/or states expressing content to be delivered to a recipient device. For example, a message may at least in part comprise a physical signal in a transmission medium that is modulated by content that is to be stored in a non-transitory storage medium at a recipient device, and subsequently processed.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

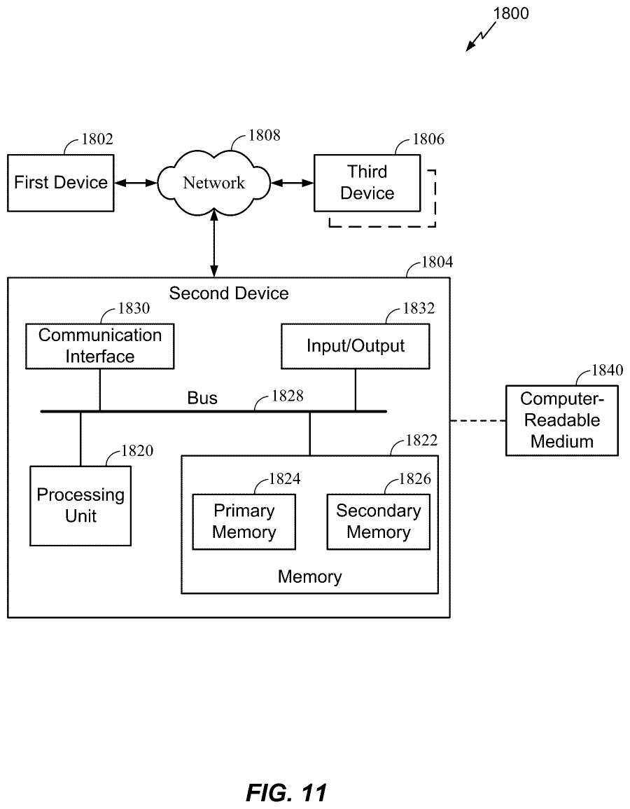

In one example embodiment, as shown in FIG. 11, a system embodiment may comprise a local network (e.g., device 1804 and medium 1840) and/or another type of network, such as a computing and/or communications network. For purposes of illustration, therefore, FIG. 11 shows an embodiment 1800 of a system that may be employed to implement either type or both types of networks. Network 1808 may comprise one or more network connections, links, processes, services, applications, and/or resources to facilitate and/or support communications, such as an exchange of communication signals, for example, between a computing device, such as 1802, and another computing device, such as 1806, which may, for example, comprise one or more client computing devices and/or one or more server computing device. By way of example, but not limitation, network 1808 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 11 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 2, 3, and 5 through 10, and in the text associated with the foregoing figure(s) of the present patent application.

Referring now to FIG. 11, in an embodiment, first and third devices 1802 and 1806 may be capable of rendering a graphical user interface (GUI) for a network device and/or a computing device, for example, so that a user-operator may engage in system use. Device 1804 may potentially serve a similar function in this illustration. Likewise, in FIG. 11, computing device 1802 (‘first device’ in figure) may interface with computing device 1804 (‘second device’ in figure), which may, for example, also comprise features of a client computing device and/or a server computing device, in an embodiment. Processor (e.g., processing device) 1820 and memory 1822, which may comprise primary memory 1824 and secondary memory 1826, may communicate by way of a communication bus 1815, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 1804, as depicted in FIG. 11, is merely one example, and claimed subject matter is not limited in scope to this particular example. FIG. 11 may further comprise a communication interface 1830 which may comprise circuitry and/or devices to facilitate transmission of messages between second device 1804 and first device 1802 and/or third device 1806 in a physical transmission medium over network 1808 using one or more network communication techniques identified herein, for example. In a particular implementation, communication interface 1830 may comprise a transmitter device including devices and/or circuitry to modulate a physical signal in physical transmission medium according to a particular communication format based, at least in part, on a message that is intended for receipt by one or more recipient devices. Similarly, communication interface 1830 may comprise a receiver device comprising devices and/or circuitry demodulate a physical signal in a physical transmission medium to, at least in part, recover at least a portion of a message used to modulate the physical signal according to a particular communication format. In a particular implementation, communication interface may comprise a transceiver device having circuitry to implement a receiver device and transmitter device.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, GNSS receiver and/or other location-identifying type capability, and/or a display with a higher degree of functionality, such as a touch-sensitive color 5D or 3D display, for example.

In FIG. 11, computing device 1802 may provide one or more sources of executable computer instructions in the form physical states and/or signals (e.g., stored in memory states), for example. Computing device 1802 may communicate with computing device 1804 by way of a network connection, such as via network 1808, for example. As previously mentioned, a connection, while physical, may not necessarily be tangible. Although computing device 1804 of FIG. 11 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 1822 may comprise any non-transitory storage mechanism. Memory 1822 may comprise, for example, primary memory 1824 and secondary memory 1826, additional memory circuits, mechanisms, or combinations thereof may be used. Memory 1822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 1822 may be utilized to store a program of executable computer instructions. For example, processor 1820 may fetch executable instructions from memory and proceed to execute the fetched instructions. Memory 1822 may also comprise a memory controller for accessing device readable-medium 1840 that may carry and/or make accessible digital content, which may include code, and/or instructions, for example, executable by processor 1820 and/or some other device, such as a controller, as one example, capable of executing computer instructions, for example. Under direction of processor 1820, a non-transitory memory, such as memory cells storing physical states (e.g., memory states), comprising, for example, a program of executable computer instructions, may be executed by processor 1820 and able to generate signals to be communicated via a network, for example, as previously described. Generated signals may also be stored in memory, also previously suggested.

Memory 1822 may store electronic files and/or electronic documents, such as relating to one or more users, and may also comprise a computer-readable medium that may carry and/or make accessible content, including code and/or instructions, for example, executable by processor 1820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, samples, observations, weights, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 11, processor 1820 may comprise one or more circuits, such as digital circuits, to perform at least a portion of a computing procedure and/or process. By way of example, but not limitation, processor 1820 may comprise one or more processors, such as controllers, microprocessors, microcontrollers, application specific integrated circuits, digital signal processors (DSPs), graphics processing units (GPUs), neural network processing units (NPUs), programmable logic devices, field programmable gate arrays, the like, or any combination thereof. In various implementations and/or embodiments, processor 1820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 11 also illustrates device 1804 as including a component 1832 operable with input/output devices, for example, so that signals and/or states may be appropriately communicated between devices, such as device 1804 and an input device and/or device 1804 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A computer-implemented method comprising:
computing an estimate of a latency in an execution of a candidate neural network architecture to be implemented on a computing platform, the computing platform comprising a computing device hosting a compiler, the estimate of the latency in the execution of the candidate neural network architecture to be based, at least in part, on:
a combination of estimated latencies of individual kernels defined in the computing platform and to be executed by the candidate neural network architecture; and
application of an overhead latency estimator to design features of the candidate neural network architecture to determine an overhead latency estimate, wherein the overhead latency estimator comprises trainable parameters determined from measured latencies of execution of sample neural networks on the computing platform.

2. The method of claim 1, wherein:
application of the overhead latency estimator comprises multiplying the estimated latencies by scalars, the scalars being determined based, at least in part, on the trainable parameters.

3. The method of claim 1, wherein:
the combination of estimated latencies of the individual kernels comprises a sum of individual estimated latencies associated with the individual kernels; and
application of the overhead latency estimator comprises adding a latency overhead term to the sum.

4. The method of claim 1, wherein the overhead latency estimator comprises:
a first neural network to compute an estimated latency based, at least in part, on an input tensor; and
a second neural network having parameters trained to map sample neural networks of multiple neural network search spaces to the input tensor.

5. The method of claim 4, wherein parameters of the first and second neural networks are trained separately.

6. The method of claim 4, wherein the multiple neural network search spaces include neural networks of different depths.

7. The method of claim 1, wherein the overhead latency estimate is determined further based, at least in part, on application of the overhead latency estimator to one or more parameters descriptive of a topology of the candidate neural network architecture.

8. The method of claim 1, wherein the individual kernels are executed by the candidate neural network architecture in a series, and wherein the combination of estimated latencies comprises a sum of latencies of the individual kernels.

9. The method of claim 1, wherein the sample neural networks and the candidate neural network architecture are selected from a neural network architecture search (NAS) space.

10. The method of claim 1, wherein the trainable parameters are determined based, at least in part, on:
application of a first training epoch to determine a first update of the trainable parameters based, at least in part, on a measured execution latency of a first sample neural network and an estimated execution latency of the first sample neural network; and
application of a second training epoch to determine a second update of the trainable parameters based, at least in part, on a measured execution latency of a second sample neural network and an estimated execution latency of the second sample neural network computed using the first update of the trainable parameters.

11. The method of claim 10, wherein the first update of the trainable parameters is determined based, at least in part, on a gradient of a loss function, the loss function computed based, at least in part, on the measured execution latency of the first sample neural network and the estimated execution latency of the first sample neural network.

12. A computing apparatus, comprising:
one or more memory devices; and
one or more processors coupled to the one or more memory devices to compute an estimate of a latency in an execution of a candidate neural network architecture to be implemented on a computing platform, the computing platform comprising a computing device hosting a compiler, the estimate of the latency in the execution of the candidate neural network architecture to be based, at least in part, on:
a combination of estimated latencies of individual kernels defined in the computing platform and to be executed by the candidate neural network architecture; and
application of an overhead latency estimator to design features of the candidate neural network architecture to determine an overhead latency estimate, wherein the overhead latency estimator comprises trainable parameters determined from measured latencies of execution of sample neural networks on the computing platform.

13. The computing apparatus of claim 12, wherein:
application of the overhead latency estimator comprises multiplying the estimated latencies by scalars, the scalars being determined based, at least in part, on the trainable parameters.

14. The computing apparatus of claim 12, wherein:
the combination of estimated latencies of the individual kernels comprises a sum of individual estimated latencies associated with the individual kernels; and
application of the overhead latency estimator comprises adding a latency overhead term to the sum.

15. The computing apparatus of claim 12, wherein the overhead latency estimator comprises:
a first neural network to compute an estimated latency based, at least in part, on an input tensor; and
a second neural network having parameters trained to map sample neural networks of multiple neural network search spaces to the input tensor.

16. The computing apparatus of claim 15, wherein parameters of the first and second neural networks are trained separately.

17. The computing apparatus of claim 15, wherein the multiple neural network search spaces include neural networks of different depths.

18. The computing apparatus of claim 12, wherein the overhead latency estimate is determined further based, at least in part, on application of the overhead latency estimator to one or more parameters descriptive of a topology of the candidate neural network architecture.

19. The computing apparatus of claim 12, wherein the trainable parameters are determined based, at least in part, on:
application of a first training epoch to determine a first update of the trainable parameters based, at least in part, on a measured execution latency of a first sample neural network and an estimated execution latency of the first sample neural network; and
application of a second training epoch to determine a second update of the trainable parameters based, at least in part, on a measured execution latency of a second sample neural network and an estimated execution latency of the second sample neural network computed using the first update of the trainable parameters.

20. An article comprising:
A storage medium comprising computer-readable instructions stored thereon, the computer-readable instructions to be executable by one or more processors of a computing device to:
compute an estimate of a latency in an execution of a candidate neural network architecture to be implemented on a computing platform, the computing platform comprising a computing device hosting a compiler, the estimate of the latency in the execution of the candidate neural network architecture to be based, at least in part, on:
a combination of estimated latencies of individual kernels defined in the computing platform and to be executed by the candidate neural network architecture; and
application of an overhead latency estimator to design features of the candidate neural network architecture to determine an overhead latency, wherein the overhead latency estimator comprises trainable parameters determined from measured latencies of execution of sample neural networks on the computing platform.
